(19) United States
(12) Patent Application Publication
(10) Pub. No.: US 2001/0009540 A1
(43) Pub. Date: Jul. 26, 2001

(54) Portable information processing apparatus with a plurality of speakers

(76) Inventor: Masanori Ryuuzaki, Yamagata (JP)

Correspondence Address: SUGHRUE, MION, ZINN, MACPEAK & SEAS, 2100 Pennsylvania Avenue, N.W., Washington, DC, 20037, US

(21) Appl. No.: 09/737,550

(22) Filed: Dec. 18, 2000

(30) Foreign Application Priority Data
Jan. 20, 2000 (JP) 2000-011297

(51) Int. Cl. G11B 3/74

(52) U.S. Cl. 369/91

(57) ABSTRACT

An object is to improve the sound quality and save the power consumption during listening to sound, in a portable information processing apparatus. The body for containing CPU is attached to a movable cover. The body and movable cover are provided, respectively, with one or more pairs of speakers for right and left channel. The sound circuit (sound control unit and amplifier unit) generates independent sound signals for each of the speakers. Only the speakers, the sound circuit and DVD drive 62 are switched on, when listening to the sound from DVD drive.

### BACKGROUND OF THE INVENTION

1. Technical Field of the Invention

The present invention relates to a portable information processing apparatus, and particularly to a portable information processing apparatus which outputs high fidelity sound from a plurality of speakers, by using sound media such as DVD (digital video disc).

2. Description of the Prior Art

Portable information processing apparatuses such as note personal computers becomes smaller and thinner, due to development in semiconductor technologies. Further, the note personal computers are being equipped with multiple functions for multimedia. However, the quality and volume of sound is not sufficient, because the sound is not a main concern and speakers are small.

The sound is improved by connecting appropriate speakers outside of the note personal computer, although the portability of the computer is sacrificed. For example, as disclosed in JP No. 003044340 (utility model), two speakers are provided on the left and right corners of a display unit equipped on a cover of the computer in order to obtain superior effect of sound.

However, the two speakers can not reproduce sufficient volume and quality of sound. Further, electric power is excessively consumed, because the power supply is switched on for the computer as a whole, even when users merely want to listen to music.

### SUMMARY OF THE INVENTION

An object of the present invention is to improve the quality and volume of sound and to save the electric power consumed by the portable information processing apparatus.

The portable information processing apparatus of the present invention comprises: a sound media drive for reading out sound data from a sound media; a sound circuit for generating one or more sound signals on the basis of the sound data for right channel and left channel independently; one or more speakers for the right channel: and one or more speakers for left channel. Here, one or more sound signals belongs to different frequency ranges.

Concretely, the portable information processing apparatus of the present invention may comprises: a body for containing CPU; a movable cover for covering the body; a sound media drive for reading out sound data from a sound media; a sound circuit for generating one or more sound signals on the basis of the sound data for right channel and left channel independently; one or more speakers for the right channel: and one or more speakers for left channel. Here, one or more sound signals belongs to different frequency ranges.

Further, the sound media drive may be a digital video disc (DVD) drive, or compact disc (CD) drive, or compact disc read only memory (CD-ROM) drive.

Further, the portable information processing apparatus may further comprises power supply control unit for switching on the speakers, the sound circuit and the sound media drive.

According to the present invention, the sound quality is better than the conventional portable information processing apparatus.

Further, according to the present invention, a three dimensional sound effect is obtained by the speakers on the movable cover of the portable information processing apparatus.

Further, the electric power consumption is saved by the independent power supply control for sound circuit.

### BRIEF EXPLANATION OF THE DRAWINGS

FIG. 1 is a plan view of the portable information processing apparatus of the present invention.

FIG. 2 is a block diagram of the portable information processing apparatus of the present invention.

FIG. 3 is a block diagram of amplifier unit 30 and its peripheral circuits of the portable information processing apparatus of the present invention.

FIG. 4A is a waveform inputted into filters 41 to 46.

FIG. 4B is a waveform outputted from woofer filters.

FIG. 4C is a waveform outputted from middle range filters.

FIG. 4D is a waveform outputted from tweeter filters.

### PREFERRED EMBODIMENT OF THE INVENTION

The embodiment of the present invention is explained, referring to the drawings.

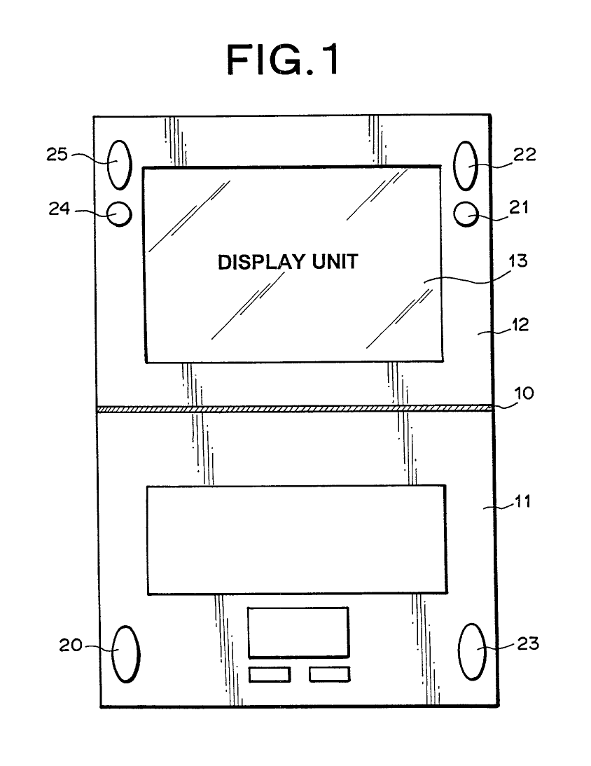

FIG. 1 is a plan view of a portable information processing apparatus such as a note personal computer, of which cover 12 is opened at 180°.

Body 10 comprises body unit 11 for containing main parts such as CPU, and cover 12 for display unit 13. Cover 12 is movable and is closed on body unit 11. Users can adjust cover 12 at angles suitable to see the display and operate the computer and to listen to the sound from speaker 21 to 26.

Right woofer 23 and left woofer 26 are provided on body unit 11, while right middle range speaker, left middle range speaker 25, right tweeter 21 and left tweeter 24 are provided on cover 12.The number of speakers is not limited to the example as shown in FIG. 1.

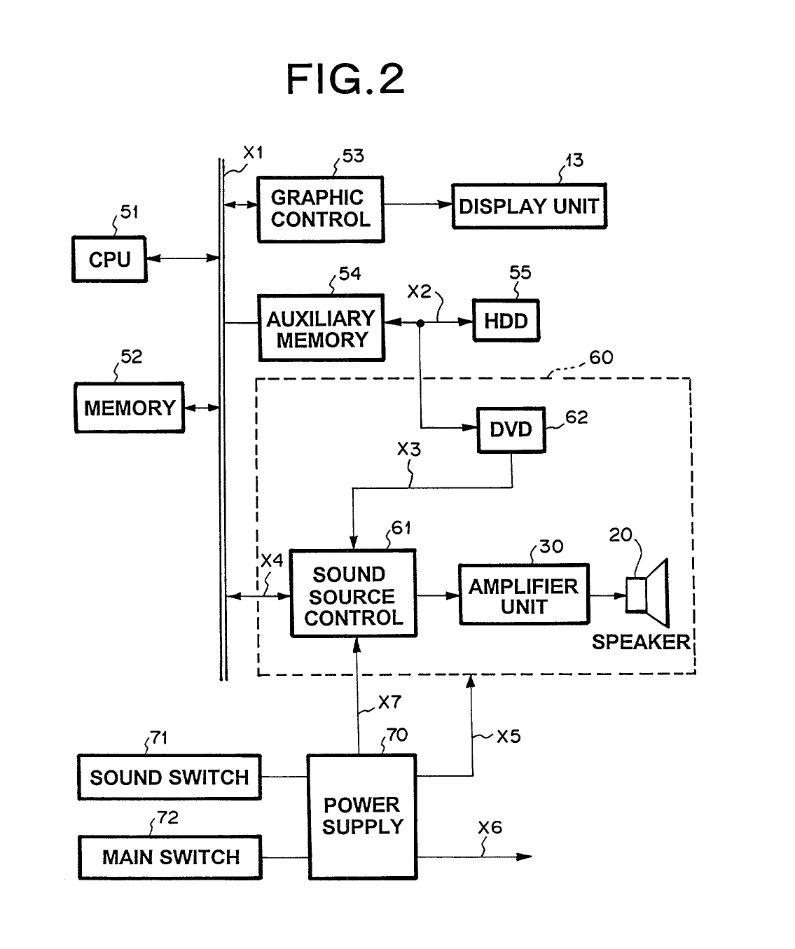

FIG. 2 is a block diagram of the portable information processing apparatus of the present invention, which comprises CPU 51 for executing programs and calculating data, memory 52 for storing programs and data, graphic control unit 53 for generating display data for display unit 13, auxiliary memory control unit 54 for transferring data to and from magnetic hard disc drive (HDD) 55 and digital video disk (DVD) drive 62, sound source control unit 61 for generating sound source for the speakers. These are connected with bus X. not-shown devices are connected with Bus X.

In place of DVD drive 62, compact disc (CD) drive, CD-ROM drive, magneto-optic (MO) disc drive, or other auxiliary memory may be connected with auxiliary memory control unit 54.

Power supply 70 comprises sound switch 71 for sound circuit 60 and main switch 72 for the portable information processing apparatus as a whole. Therefore, the electric power is supplied only to sound circuit 60 by switching on sound switch 71, when main switch 72 is turned off. Power supply line X5 is connected with sound circuit 60, while supply line X6 s connected with the portion except sound circuit 60. Sound data is inputted into sound source control unit 61 through signal line X3 under the control of sound switch signal X7 when main switch 72 is off and sound switch 71 is on. Otherwise, the sound data is inputted into and outputted from sound source control unit 61 under the control of sound switch signal X7.

Amplifier unit 30 outputs sound signal to speaker 20 on the basis of the output from sound source control unit 61. Sound source control unit 61 comprises an A/D converter for the signals from DVD drive 62 and CPU 51, and an attenuator for adjusting the volume of speaker output.

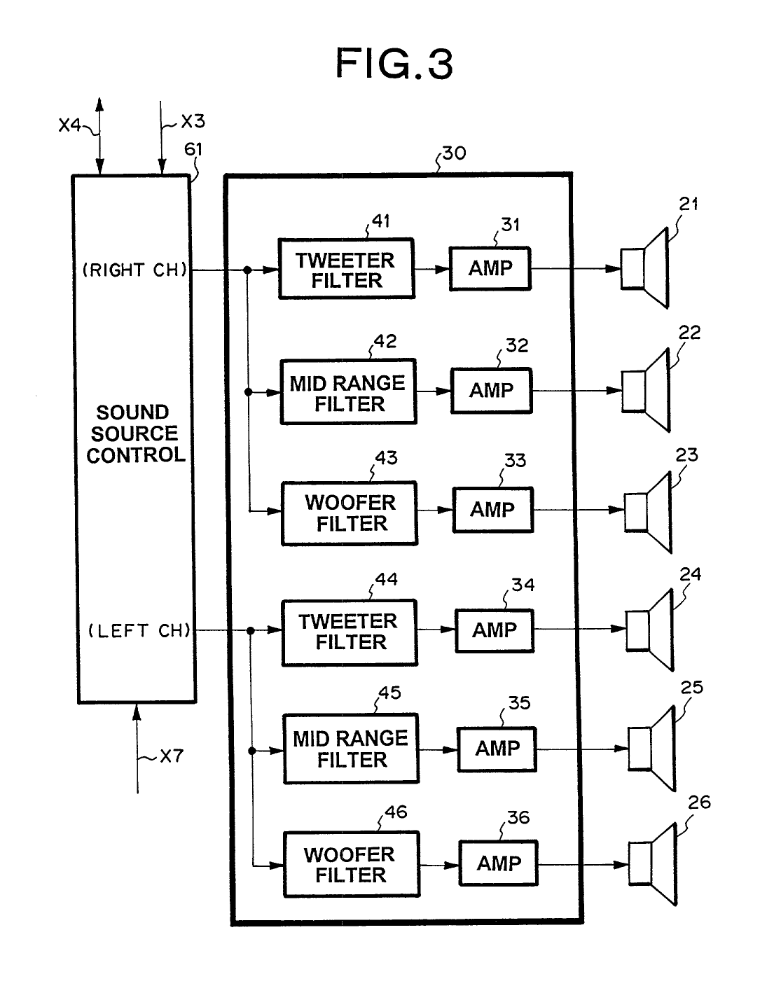

FIG. 3 is a block diagram of amplifier unit 30 which comprises filters 41 to 46 and amplifiers 31 to 36. The right channel signals from sound source control unit 61 is connected with tweeter filter 41, middle range filter 42 and woofer filter 43, while the right channel signals from sound source control unit 61 is connected with tweeter filter 44, middle range filter 45 and woofer filter 46. The outputs from filters 41 to 46 are amplified by amplifiers 31 to 36, respectively, and outputted towards speakers 21 to 26, respectively.

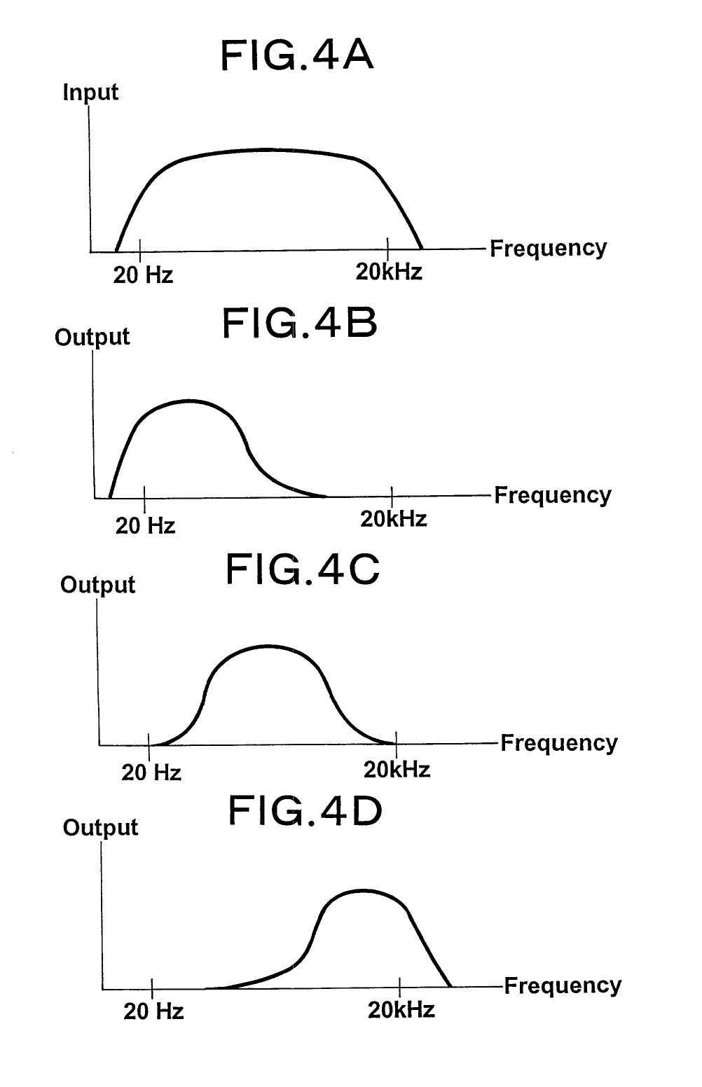

FIGS. 4A is a wave form inputted into filters 41 to 46. FIG. 4B is a waveform outputted from woofer filters 43 and 46. FIG. 4C is a waveform outputted from middle range flters 42 and 45. FIG. 4D is a waveform outputted from tweeter filters 41 and 44. The input sound signal is divided into bass range, middle range, and high tone range by filters 41 to 46. the divided signals are amplified independently by amplifiers 31 to 36. Speaker s 23 and 26 is suitable for bass ranfe, speakers 22 and 25 are suitable for middle range, and speakers 21 and 24 are suitable for high tone range.

Next, the operation of the portable information processing apparatus of the present invention is explained about a case wherein sound is play-backed from a media on DVD drive 62, when main switch 72 is turned on. The user sets up the sound media and instructs to play-back the sound media. Then, CPU 51 has auxiliary memory control unit 54 transfer to memory 52 the sound data of the sound media in appropriate segment unit, by using a not-shown play-back execution program. the sound data is transferred directly to memory 52, or transferred through CPU 51 to memory 52. The sound data is further transferred from memory 52 to sound control unit 61 by the play-back execution program.

Then, sound source control unit 61 generates 2-channel (LR) analog signals and send them to amplifier unit 30 which filters them by filters 41 to 46, amplifies them by amplifiers 31 to 36, and outputs them to speakers 21 to 26. This procedures are repeated until the user instructs to stop the play-back of sound.

Next, an explanation of the operation of the portable information processing apparatus of the present invention is made concerning a play-back from media drives such as HDD 55. After the play-back instruction by the user, CPU 51 has auxiliary memory control unit 54 transfer to memory 52 the sound data of the sound media in appropriate segment unit, by using a not-shown play-back execution program. The sound data is further transferred from memory 52 to sound control unit 61 by the play-back execution program. The sound from HDD 55 is play-backed likewise the sound from DVD drive 62.

Thus, the sound quality is superior, because three speakers for right and left channels are fed by suitable sound signals independently amplified by the amplifiers of amplifier unit 30. The sufficient sound volume is obtained without degrading the sound quality, because the sound output is divided inn three frequency ranges. Further, the sound effect becomes better, because the angle of speakers on cover 12 is adjusted freely and easily.

Next, the operation ot the portable information processing apparatus of the present invention is explained, concerning the play-back, when main switch 72 is off and sound switch 71 is on, wherein the sound data is supplied only by DVD drive 62. When the user sets up a sound media on DVD drive 62 and instructs the play-back thereof, the sound data from DVD drive 62 is sent directly to sound control unit 61 through signal line X3. Here, the play-back instruction may be executed by operating a switch of DVD drive 62.

Then, sound source control unit 61 generates 2-channel (LR) analog signals and send them to amplifier unit 30 which filters them by filters 41 to 46, amplifies them by amplifiers 31 to 36, and outputs them to speakers 21 to 26. Signal line X3 is selected by not-shown switching circuit on the basis of sound swtiching signal X7 from power supply 70.

Signal line X3 may be selected by not-shown other switching circuit for detecting, for example, the status of CPU 51. In this case, signal line X3 is selected, when the electric power is not supplied to CPU 51.

As explained above, the user can listen to the music from DVD drive 62, saving the power consumption of the computer apparatus, because it is possible to switch on only DVD drive 62, sound source control unit 61 and amplifier unit 30. Here, DVD drive 62 may be substituted by other memory apparatus such as CD-ROM drive.

What is claimed is:

1. A portable information processing apparatus which comprises:
a CPU for processing information;
a sound media drive for reading out sound data from a sound media;
a sound circuit for generating one or more sound signals on the basis of said sound data for right channel and left channel independently;
one or more speakers for said right channel: and
one or more speakers for left channel;
wherein said one or more sound signals belong to different frequency ranges.

2. A portable information processing apparatus which comprises:
a CPU for processing information;
a body for containing said CPU;
a movable cover for covering said body;
a sound media drive for reading out sound data from a sound media;
a sound circuit for generating one or more sound signals on the basis of said sound data for right channel and left channel independently;
one or more speakers for said right channel: and
one or more speakers for left channel;
wherein said one or more sound signals belong to different frequency ranges.

3. The portable information processing apparatus according to claim 1, wherein said sound media drive is a digital video disc (DVD) drive, or compact disc (CD) drive, or compact disc read only memory (CD-ROM) drive.

4. The portable information processing apparatus according to claim 2, wherein said sound media drive is a digital video disc (DVD) drive, or compact disc (CD) drive, or compact disc read only memory (CD-ROM) drive.

5. The portable information processing apparatus according to claim 1, which further comprises a sound switch for supplying said sound media drive and said sound circuit with electric power, when said CPU is not supplied with electric power.

6. The portable information processing apparatus according to claim 2, which further comprises a sound switch for supplying said sound media drive and said sound circuit with electric power, when said CPU is not supplied with electric power.

7. The portable information processing apparatus according to claim 1, which further comprises a main switch for supplying said CPU, said sound media drive and said sound circuit with electric power by turning on said main switch, wherein only said sound media drive and said sound circuit are supplied with electric power, when said main switch is turned off and said sound switch is turned on.

8. The portable information processing apparatus according to claim 2, which further comprises a main switch for supplying said CPU, said sound media drive and said sound circuit with electric power by turning on said main switch, wherein only said sound media drive and said sound circuit are supplied with electric power, when said main switch is turned off and said sound switch is turned on.
